(19) United States
(12) Patent Application Publication
(10) Pub. No.: US 2007/0286927 A1
(43) Pub. Date: Dec. 13, 2007

(54) Low-Density Non-SBR Chewing Gum

(75) Inventors: Hans Erik Nielsen, Hovedgaard (DK); Nesim Acar, Istanbul (TR); Albert Levi, Istanbul (TR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Intergum Gida Sanayi ve Ticaret A.S.

(21) Appl. No.: 11/830,225

(22) Filed: Jul. 30, 2007

Related U.S. Application Data
(63) Continuation-in-part of application No. 10/240,585, filed on Oct. 1, 2002, now abandoned.

(51) Int. Cl. A23G 4/06

(52) U.S. Cl. 426/6

(57) ABSTRACT

An aerated low-density gum piece is formed of a substantially homogeneous mixture consisting essentially of: (a) non-styrene butadiene gum base consisting essentially of: 2 to 20 wt. % of a synthetic elastomer selected from the group consisting of polyisobutylene, isoprene isobutylene, isoprene isobutylene copolymer, polyethylene, and mixtures thereof, up to 10 wt. % natural elastomer or natural gum, 2 to 22 wt. % polyvinyl acetate, 20% to 30 wt. % elastomer solvent, 2 to 20 wt. % filler, 2 to 22 wt. % wax, emulsifier, 0.5 to 9 wt. % partially or fully hydrogenated fat, and up to 0.1 wt. % of an antioxidant; (b) flavor in an amount up to 2.5% by weight of the gum piece; and (c) intensive sweetener in an amount up to 1.5% by weight of the gum piece. The gum piece has a density of 0.5 to 0.9 g/ml.

### CROSS-REFERENCE TO RELATED APPLICATION

This application is a continuation-in-part of U.S. patent application Ser. No. 10/240,585 filed on Oct. 1, 2002, currently pending, the entire disclosure of which is hereby incorporated herein by reference.

### BACKGROUND OF THE INVENTION

The present invention relates to a low-density chewing gum product made from a non-styrene butadiene rubber gum base composition, having a density from 0.5 g/ml to 0.9 g/ml and having a soft and elastic consistency and large bubbles.

Chewing gum generally comprises a water-insoluble portion (the gum base) that remains in the oral cavity for a long period of time, and a water-soluble portion that dissolves during chewing. Flavor and sweeteners such as sugar, glucose, sorbitol, xylitol, if any, are primarily provided by the water-soluble portion, while organoleptic properties such as structure, elasticity, film-forming capacity, tackiness, softness, etc., are usually provided by the gum base portion. To obtain the desired properties in a chewing gum product, the gum base is prepared from ingredients selected on the basis of their organoleptic properties, their workability, their compatibility, and their shelf-life properties.

The present invention relates to a type of gum found in Turkey and some of the surrounding countries in the middle east and some of the southern states of the former Soviet Union. The gum product consists primarily of gum base and flavor, and frequently does not include any sweeteners or softeners. The gum is aerated to improve flexibility and softness.

This is a traditional product in this region of the world. Earlier, people were used to chewing a resinous substance called gum mastic that is collected from a special pistachio tree. This has been chewed for centuries to keep the mouth moisturized with saliva when people were working in the fields. This tradition has continued until today and people in general still like to chew this type of product.

The local gum industry accordingly developed products in which the gum is based on a gum base containing only synthetic ingredients including styrene butadiene rubber (SBR). This is combined with a very low content of flavor and is aerated to create the final gum. In the local market this type of product is called “oriental gum”.

Styrene butadiene rubber (SBR rubber) has been the only rubber that could be used in mechanically aerated gums because of its excellent film-forming properties that are needed to entrap and hold the air bubbles inside the gum after aeration. It has not been possible until the present invention to use synthetic elastomers like polyisobutylene or isoprene isobutylene copolymer because of their lack of film-forming properties.

The flavors used in this type of product include flavors such as gum mastic, rose, clover, and similar flavors. Today there are also more widely known flavors introduced like fruit and mint flavors, but the traditional flavors are still widely preferred.

The known products on the market use gum bases that have intense off-taste because of the inclusion of styrene butadiene rubber and low-cost rosin esters like glycerol ester of rosin. The typical off-taste of this type of gum can be described as a bitter, burned, or smoked type of flavor. Styrene butadiene rubber is known for this off-taste because it is an emulsion polymer whereas other synthetic polymers are manufactured in solvent and without the use of emulsifiers. The emulsifiers used in styrene butadiene copolymer are fatty acid emulsifiers that normally become scorched during the gum base manufacturing process, thus resulting in the characteristic bitter or burned off-taste.

The gum base of the present invention has proved to have a very low gum base off-taste and a pure white color in the final product.

The state of the art formulas and the technology have been based on a styrene butadiene rubber as the elastomer because styrene butadiene rubber formulas are homogenous and have good stretching properties that allow them to be pulled or aerated with air under pressure, and they readily trap air bubbles that remain in the gum for a long period of time. Prior to the present invention this has not been possible with the non-styrene butadiene rubber (non-SBR) formulas because they are not sufficiently homogenous to permit sufficient formation and entrapment of air bubbles.

This likewise has not been possible with prior non-styrene butadiene rubber formulas as they also are not completely homogenous.

### BRIEF SUMMARY OF THE INVENTION

The non-styrene butadiene rubber formula in the present invention shows good entrapment of air bubbles and shows good stretching properties when pulled and shows good cohesive properties when mechanically aerated under pressure.

In accordance with one aspect of the invention, an aerated low-density gum piece is formed of a substantially homogeneous mixture consisting essentially of:
(a) non-styrene butadiene gum base consisting essentially of:
   2 to 20 wt. % of a synthetic elastomer selected from the group consisting of polyisobutylene, isoprene isobutylene, isoprene isobutylene copolymer, polyethylene, and mixtures thereof,
   up to 10 wt. % natural elastomer or natural gum,
   2 to 22 wt. % polyvinyl acetate,
   20 to 30 wt. % elastomer solvent,
   2 to 20 wt. % filler,
   2 to 22 wt. % wax,
   emulsifier,
   0.5 to 9 wt. % partially or fully hydrogenated fat, and
   up to 0.1 wt. % of an antioxidant,
   where the above wt. % values are based on the weight of the gum base;
(b) flavor in an amount up to 2.5% by weight of the gum piece; and
(c) intensive sweetener in an amount up to 1.5% by weight of the gum piece.

The mixture is mechanically aerated to trap air bubbles therein and is formed into the gum piece such that the gum piece has a density of 0.5 to 0.9 grams per milliliter.

In preferred embodiments, the synthetic elastomer selected from the group consisting of polyisobutylene, isoprene isobutylene, isoprene isobutylene copolymer, polyethylene, and mixtures thereof, comprises from about 6 to 12 wt. % of the gum base. The flavor preferably can comprise from 0.2 to 2.5% by weight of the gum piece. The intensive sweetener preferably can comprise from 0.01 to 0.5% by weight of the gum piece.

The gum base portion is prepared as a single process or as a 2-step process that may include a preparation of a premix. The selection of these processes will depend on the selection of raw materials used for the gum base. The gum base manufactured in the state of the art is manufactured in a double-jacketed Z blade mixer heated with steam or oil.

The mixing procedure starts with addition of some resin and filler to the rubber, which is mixed thoroughly. After the raw material is absorbed, more filler and resin are added. Mixing is continued until all resin and filler are added. Then, waxes are added slowly to prevent fast melting of too much wax and in order to ensure fast uptake of the liquid wax in the mixture. Later other softeners are added. To provide a homogenous mixture, the blend is mixed 10 to 15 minutes after last addition of raw materials and before the mixing procedure is ended. The gum base is usually taken out of the mixer at a temperature of about 100° C. When the gum base is manufactured, it is used directly for the manufacture of the non-calorie low-density gum product. This means that flavor can be added to the gum base along with some auxiliary components. As mixed thoroughly and dispersed into the gum base, it is ready for gum production.

### DETAILED DESCRIPTION OF THE INVENTION

The present invention now will be described more fully hereinafter, in which some but not all embodiments of the inventions are described. Indeed, these inventions may be embodied in many different forms and should not be construed as limited to the embodiments set forth herein; rather, these embodiments are provided so that this disclosure will satisfy applicable legal requirements.

The gum base of the present invention is a non-styrene butadiene rubber gum base with improved elastic chewing characteristics of non-caloric low-density gum. The gum base according to this invention does not stick to natural or artificial teeth or dental work.

The non-styrene butadiene rubber gum base of the present invention shows good miscibility properties with air and shows a good cohesive strength to keep the air bubbles trapped during processing and storage of the final product.

The non-styrene butadiene rubber gum base of the present invention provides pure white color of the final gum product. The non-styrene butadiene rubber gum base of the present invention provides a flavor release that is improved due to decreased off taste and odor from the gum base.

The gum base of the present invention consists essentially of about 2 to 20% by weight of synthetic elastomer, 0 to 10% by weight of a natural elastomer, 20 to 30% by weight of elastomer plasticizer, 2 to 20% by weight of a filler, 2 to 22% by weight of a synthetic resin, 0.5 to 4% by weight of mono diglyceride emulsifier, 1 to 10% by weight of a distilled monoglyceride, 1 to 8% of an acetylated monoglyceride, 12 to 24% by weight of petroleum wax, 0.5 to 9% by weight of a partially or fully hydrogenated animal or vegetable oil, and from 0 to 0.1% of an antioxidant.

The synthetic elastomers may include, but are not limited to, polyisobutylene, isoprene isobutylene rubber (butyl rubber), isoprene isobutylene copolymer, polyethylene, polyvinyl acetate with a molecular weight up to 50,000 or vinyl acetate-vinyl laurate copolymer or blends thereof.

The elastomer plasticizers may include but not limited to glycerol ester of tall oil rosin, glycerol ester of wood rosin, glycerol ester of gum rosin, glycerol ester of polymerized gum rosin, glycerol ester of polymerized wood rosin, glycerol ester of polymerized tall oil rosin, methyl ester of partially hydrogenated gum rosin, methyl ester of partially hydrogenated wood rosin, glycerol ester of dimerized gum rosin, glycerol ester of dimerized wood rosin, glycerol ester of partially dimerized tall oil rosin, glycerol ester of partially hydrogenated wood rosin, glycerol ester of partially hydrogenated gum rosin, penta erythritol ester of partially hydrogenated gum rosin. Pentaerythritol ester of wood rosin, copolymer of alpha and beta pinene or dipentene also called delta limonene or blends thereof.

Fillers/texturizers may include, but are not limited to, magnesium carbonate, calcium carbonate, ground limestone, silicates such as magnesium and aluminum silicate, clay, alumina, talc, titanium oxide, mono-, di- and tri-calcium phosphate, cellulose polymers and combinations thereof, kaolin, aluminum oxide, or silicium oxide, or blends thereof.

Fats and oils may include, but are not limited to, partially or fully hydrogenated vegetable oil such as soybean, palm, coconut, sunflower seed, rapeseed, corn, olive, shea nut or other vegetables, or fats such as tallow or lanolin. Also, the gum base may contain glycerol diacetate (diacetin), glycerol triacetate (triacetin), or blends thereof.

Waxes may include, but are not limited to, paraffin wax, micro crystalline wax, petroleum wax, synthetic paraffin wax manufactured according to the Fisher Tropsch reaction, polyethylene wax with a minimum molecular weight of 2000, vegetable wax such as carnauba wax, candelilla wax, or bees wax, or blends thereof.

Emulsifiers may contain at least one of mono di-glyceride with a maximum mono ester content of 60%, a distilled mono glyceride with a minimum mono ester content of 90%, or an acetylated mono glyceride with a maximum saponification value of 425. The gum base according to this invention may also contain citric acid esters of mono glycerides, stearoyl lactylates, sorbitan esters of fatty acids, lactic acid esters of mono glycerides, diacetyl. tartaric acid esters of mono glycerides, propylene glycol esters of fatty acids, poly glycerol esters of fatty acids and sucrose ester of fatty acids and blends thereof.

Antioxidants may include, but are not limited to, antioxidants like THHQ (tertiary butyl hydroquinone), BHT (butylated hydroxytoluene), BHA (butylated hydroxyanisole), derivatives of vitamin E, propyl gallate, octyl gallate, dodecyl gallate, ascorbic acid, ascorbyl palmitate, or blends thereof.

Intensive sweeteners that can be used in accordance with the invention include aspartame, acetsulfame K, neohesperidine, alitame, sucralose, sodium saccharin, cyclamate, and mixtures thereof.

Mixing is conducted in a double-jacketed Z blade mixer heated with steam to a temperature of 120° C. following the steps of a) mixing all elastomers, part of high melting terpene or polymerized rosin resins and filler thoroughly; b) adding rest of the high melting terpene or polymerized rosin resins and part of filler and continuing mixing; 8 c) adding polyvinyl acetate and part of filler gradually and continuing mixing; d) adding low melting rosin ester resins gradually and continuing mixing e) adding triacetin and continuing mixing; f) adding wax and antioxidants gradually and continuing mixing; and finally g) adding emulsifiers and fats and continuing mixing until a homogeneous mass is produced.

After the homogenous mass is obtained, mixing is continued for another 10 minutes to provide a good homogeneity between the components and heating the gum base uniformly to 100° C. Depending on the combination of elastomers used, mixing time can vary from 2 to 5 hours. After the gum base mixing procedure is finished, the gum base can be poured out and cooled down and molded into slabs or pelletized in a proper equipment.

An alternative is to pump the gum base directly to a holding tank where it is cooled to 80 to 90° C. Afterwards, the gum base is passed through a heat exchanger and is cooled down to a temperature between 45 and 65° C. Before the gum base enters into the aerating device, flavor and other additives are injected into the gum base and the resulting substantially homogeneous mixture is stirred continuously during aeration. Aeration is performed for a sufficient length of time such that the mixture, when formed into finished gum pieces, yields gum pieces having a density of 0.5 to 0.9 g/ml. The other alternative is to mix the gum base with flavor and then cool the gum down in water and aerate the gum in a pulling machine.

Preferred gum base formulations used for the production of low-density non-SBR gum pieces in accordance with the present invention are as follows:

| Raw Material | Example 1 | Example 2 | Example 3 |
|---|---|---|---|
| PIB Mw 900,000 | 5% | 6% | — |
| PIB Mw 450,000 | 5% | — | 8% |
| PIB Mw 50,000 | 5% | 6% | 4% |
| Isoprene isobutylene copolymer | — | — | — |
| Polyterpene resin | — | — | — |
| Glycerolester of polymerized rosin | 8% | 6% | 4% |
| Glycerolester of rosin | 3% | 6% | 9% |
| Glycerolester of hydrogenated rosin | 12% | 9% | 6% |
| Methylester of hydrogenated rosin | — | 0.5% | 1% |
| Polyvinyl acetate 15,000 Mw | 7% | — | — |
| Polyvinyl acetate 25,000 Mw | 7% | 10% | — |
| Polyvinyl acetate 45,000 Mw | 7% | 10% | 15% |
| Polyvinyl acetate 55,000 Mw | — | — | 7% |
| Calcium carbonate | 7% | 3.9% | 5% |
| Talc | 6.9% | 2% | 3.9% |
| Mono diglyceride max. 55% ME | 0.5% | 2% | 4% |
| Distilled monoglyceride min. | 1% | 2% | 1% |
| 90% ME | | | |
| Acetylated monoglyceride | 1% | 7% | 2% |
| Paraffin wax | 5% | 10% | 10% |
| Microcrystalline wax | 15% | 12% | 6% |
| Candelilla wax | — | — | 5% |
| Partially hydrogenated vegetable oil | 1% | — | 2% |
| Fully hydrogenated vegetable oil | 1% | 2% | — |
| Triacetin | 0.5% | 1.5% | 1% |
| Antioxidant | 0.1% | 0.1% | 0.1% |
| Total | 100% | 100% | 100% |
| Raw Material | Example 4 | Example 5 | Example 6 |
| PIB Mw 900,000 | — | — | — |
| PIB Mw 450,000 | 8% | 6% | 3% |
| PIB Mw 50,000 | 4% | 6% | 9% |
| Isoprene isobutylene copolymer | — | — | — |
| Polyterpene resin | 2% | 4% | 6% |
| Glycerolester of polymerized rosin | 8% | 6% | 4% |
| Glycerolester of rosin | 3% | 6% | 9% |
| Glycerolester of hydrogenated rosin | 12% | 9% | 6% |
| Methylester of hydrogenated rosin | — | 0.5% | 1% |
| Polyvinyl acetate 15,000 Mw | — | — | 5% |
| Polyvinyl acetate 25,000 Mw | 6% | 5% | — |
| Polyvinyl acetate 45,000 Mw | 7% | 10% | 10% |
| Polyvinyl acetate 55,000 Mw | 8% | 5% | 7% |
| Calcium carbonate | 10% | 3.9% | 5% |
| Talc | 6.9% | 2% | 3.9% |
| Mono diglyceride max. 55% ME | 0.5% | 2% | 4% |
| Distilled monoglyceride min. | 1% | 2% | 1% |
| 90% ME | | | |
| Acetylated monoglyceride | 1% | 7% | 2% |
| Paraffin wax | 5% | 10% | 10% |
| Microcrystalline wax | 15% | 12% | 6% |
| Candelilla wax | — | — | 5% |
| Partially hydrogenated vegetable oil | 1% | — | 2% |
| Fully hydrogenated vegetable oil | 1% | 2% | — |
| Triacetin | 0.5% | 1.5% | 1% |
| Antioxidant | 0.1% | 0.1% | 0.1% |
| Total | 100% | 100% | 100% |
| Raw Material | Example 7 | Example 8 | Example 9 |
| PIB Mw 900,000 | — | — | — |
| PIB Mw 450,000 | — | 6% | — |
| PIB Mw 50,000 | — | — | 3% |
| Isoprene isobutylene copolymer | 8% | 6% | 9% |
| Chicle | 4% | — | 5% |
| Polyterpene resin | — | 4% | 6% |
| Glycerolester of polymerized rosin | 10% | 9% | 7% |
| Glycerolester of rosin | 3% | — | 7% |
| Glycerolester of hydrogenated rosin | 12% | 12% | — |
| Methylester of hydrogenated rosin | — | 0.5% | 1% |
| Polyvinyl acetate 15,000 Mw | 7% | — | — |
| Polyvinyl acetate 25,000 Mw | 7% | 10% | — |
| Polyvinyl acetate 45,000 Mw | 7% | 10% | 15% |
| Polyvinyl acetate 55,000 Mw | — | — | 7% |
| Calcium carbonate | 10% | 3.9% | 5% |
| Talc | 6.9% | 2% | 3.9% |
| Mono diglyceride max. 55% ME | 0.5% | 2% | 4% |
| Distilled monoglyceride min. | 1% | 2% | 1% |
| 90% ME | | | |
| Acetylated monoglyceride | 1% | 7% | 2% |
| Paraffin wax | 5% | 10% | 10% |
| Microcrystalline wax | 15% | 12% | 6% |
| Candelilla wax | — | — | 5% |
| Partially hydrogenated vegetable oil | 1% | — | 2% |
| Fully hydrogenated vegetable oil | 1% | 2% | — |
| Triacetin | 0.5% | 1.5% | 1% |
| Antioxidant | 0.1% | 0.1% | 0.1% |
| Total | 100% | 100% | 100% |
| | Example | Example | Example |
| Raw Material | 10 | 11 | 12 |
| PIB Mw 900,000 | 4% | 6% | — |
| PIB Mw 450,000 | 4% | — | 8% |
| PIB Mw 50,000 | 4% | 6% | 4% |
| Isoprene isobutylene copolymer | — | — | — |
| Polyterpene resin | 2% | 4% | 6% |
| Glycerolester of polymerized rosin | 8% | 6% | 4% |
| Glycerolester of rosin | 3% | 6% | 9% |
| Glycerolester of hydrogenated rosin | 12% | 9% | 6% |
| Methylester of hydrogenated rosin | — | 0.5% | 1% |
| Polyvinyl acetate 15,000 Mw | 7% | — | — |
| Polyvinyl acetate 25,000 Mw | 7% | 10% | — |
| Polyvinyl acetate 45,000 Mw | 7% | 10% | 15% |
| Polyvinyl acetate 55,000 Mw | — | — | 7% |
| Calcium carbonate | 10% | 3.9% | 5% |
| Talc | 6.9% | 2% | 3.9% |
| Mono diglyceride max. 55% ME | 5.5% | 2% | 4% |
| Distilled monoglyceride min. | 1% | 7% | 1% |
| 90% ME | | | |
| Acetylated monoglyceride | 1% | 7% | 2% |
| Paraffin wax | 5% | 10% | — |
| Microcrystalline wax | 10% | 7% | 10% |
| Candelilla wax | — | — | 5% |
| Partially hydrogenated vegetable oil | 1% | — | 2% |
| Fully hydrogenated vegetable oil | 1% | 2% | 5% |
| Triacetin | 0.5% | 1.5% | 1% |
| Antioxidant | 0.1% | 0.1% | 0.1% |
| Total | 100% | 100% | 100% |
| | Example | Example | Example |
| Raw Material | 13 | 14 | 15 |
| PIB Mw 900,000 | — | — | 9% |
| PIB Mw 450,000 | 10% | — | — |
| PIB Mw 50,000 | — | — | — |
| Isoprene isobutylene copolymer | — | 12% | — |
| Polyterpene resin | 2% | 4% | 6% |
| Glycerolester of polymerized rosin | 8% | 6% | 4% |
| Glycerolester of rosin | 3% | 6% | 9% |
| Glycerolester of hydrogenated rosin | 12% | 9% | 6% |
| Methylester of hydrogenated rosin | — | 0.5% | 1% |
| Polyvinyl acetate 15,000 Mw | 7% | — | — |
| Polyvinyl acetate 25,000 Mw | 7% | 10% | — |
| Polyvinyl acetate 45,000 Mw | 7% | 10% | 15% |
| Polyvinyl acetate 55,000 Mw | — | — | 7% |
| Calcium carbonate | 12% | 3.9% | 6% |
| Talc | 6.9% | 2% | 3.9% |
| Mono diglyceride max. 55% ME | 0.5% | 2% | 4% |
| Distilled monoglyceride min. | 1% | 2% | 1% |
| 90% ME | | | |
| Acetylated monoglyceride | 1% | 7% | 2% |
| Paraffin wax | 5% | 10% | 10% |
| Microcrystalline wax | 15% | 12% | 6% |
| Candelilla wax | — | — | 5% |
| Partially hydrogenated vegetable oil | 1% | — | 2% |
| Fully hydrogenated vegetable oil | 1% | 2% | — |
| Triacetin | 0.5% | 1.5% | 1% |
| Antioxidant | 0.1% | 0.1% | 0.1% |
| Total | 100% | 100% | 100% |

In the description and claims, the gum base is described as “consisting essentially of” various enumerated ingredients, and the gum is described as a “non-SBR” gum; however, it is within the scope of the appended claims to include minor percentages of one or more additional ingredients (e.g., a small amount of SBR), as long as the inclusion of the additional ingredient(s) does not materially alter the basic characteristics of the gum such as its ability to entrap and hold air bubbles, its low off-taste, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An aerated low-density gum piece formed of a substantially homogeneous mixture consisting essentially of:
(a) non-styrene butadiene gum base consisting essentially of:
2 to 20 wt. % of a synthetic elastomer selected from the group consisting of polyisobutylene, isoprene isobutylene, isoprene isobutylene copolymer, polyethylene, and mixtures thereof,
up to 10 wt. % natural elastomer or natural gum,
2 to 22 wt. % polyvinyl acetate,
20 to 30 wt. % elastomer solvent,
2 to 20 wt. % filler,
2 to 22 wt. % wax,
emulsifier,
0.5 to 9 wt. % partially or fully hydrogenated fat, and
up to 0.1 wt. % of an antioxidant,
where the above wt. % values are based on the weight of the gum base;
(b) flavor in an amount up to 2.5% by weight of the gum piece; and
(c) intensive sweetener in an amount up to 1.5% by weight of the gum piece;
wherein the mixture is mechanically aerated to trap air bubbles therein and is formed into the gum piece such that the gum piece has a density of 0.5 to 0.9 grams per milliliter.

2. The aerated low-density gum piece of claim 1, wherein the synthetic elastomer of the gum base comprises up to 25% by weight of isobutylene isoprene copolymer and 75% to 100% by weight of polyisobutylene with a molecular weight between 100,000 and 500,000.

3. The aerated low-density gum piece of claim 1, wherein the elastomer solvent is selected from the group consisting of glycerol ester of rosin, glycerol ester of polymerized rosin, glycerol ester of partially hydrogenated rosin, methyl ester of partially hydrogenated rosin, glycerol ester of dimerized rosin, poly terpene resin, and mixtures thereof.

4. The aerated low-density gum piece of claim 1, wherein the polyvinyl acetate has a molecular weight of 15,000 to 55,000.

5. The aerated low-density gum piece of claim 1, wherein the filler is selected from the group consisting of calcium carbonate, talc, and mixtures thereof.

6. The aerated low-density gum piece of claim 5, wherein the filler comprises a mixture of calcium carbonate and talc in a weight ratio of between 1:1 and 7:1.

7. The aerated low-density gum piece of claim 1, wherein the emulsifier is selected from the group consisting of mono diglyceride, distilled mono glyceride, acetylated mono glyceride, and mixtures thereof.

8. The aerated low-density gum piece of claim 7, wherein the emulsifier comprises mono diglyceride, distilled mono glyceride, and acetylated mono glyceride in relative weight proportions of: 1:1 to 3:1:2.

9. The aerated low-density gum piece of claim 7, wherein the emulsifier comprises 0.5 to 4 wt. % mono diglyceride with a maximum mono ester content of 60%, 1 to 10 wt. % distilled mono glyceride, and 1 to 8 wt. % acetylated mono glyceride.

10. The aerated low-density gum piece of claim 1, wherein the wax comprises a mixture of petroleum wax and Fisher Tropsch wax.

11. The aerated low-density gum piece of claim 10, wherein the petroleum wax and Fisher Tropsch wax are present in a ratio of 1:1 to 20:1.

12. The aerated low-density gum piece of claim 1, wherein the fat comprises a vegetable oil.

13. The aerated low-density gum piece of claim 1, wherein the intensive sweetener is selected from the group consisting of aspartame, acetsulfame K, neohesperidine, alitame, sucralose, sodium saccharin, cyclamate, and mixtures thereof.

14. The aerated low-density gum piece of claim 1, wherein the synthetic elastomer selected from the group consisting of polyisobutylene, isoprene isobutylene, isoprene isobutylene copolymer, polyethylene, and mixtures thereof, makes up 6 to 12 wt. % of the gum base.

15. The aerated low-density gum piece of claim 1, wherein the flavor makes up 0.2 to 2.5% by weight of the gum piece.

16. The aerated low-density gum piece of claim 1, wherein the intensive sweetener makes up 0.01 to 0.5% by weight of the gum piece.
